(19) United States
(12) Patent Application Publication
(10) Pub. No.: US 2013/0077356 A1
(43) Pub. Date: Mar. 28, 2013

(54) DC-DC CONVERTERS

(71) Applicant: TEXAS INSTRUMENTS INCORPORATED, DALLAS, TX (US)

(72) Inventor: ISAAC COHEN, Dix Hills, NY (US)

(73) Assignee: TEXAS INSTRUMENTS INCORPORATED, DALLAS, TX (US)

(21) Appl. No.: 13/630,181

(22) Filed: Sep. 28, 2012

Related U.S. Application Data
(60) Provisional application No. 61/540,185, filed on Sep. 28, 2011.

(51) Int. Cl. H02M 3/335

(52) U.S. Cl. 363/21.02

(57) ABSTRACT

A DC-DC converter includes a waveform generator that generates an output waveform for the DC-DC converter based on a DC input voltage. A rectifier rectifies the output waveform from the waveform generator to generate a rectified voltage for the DC-DC converter. A tank circuit having an inductor and a capacitor can be configured to have a resonant frequency that is correlated with a frequency of the output waveform, wherein the capacitor of the tank circuit also functions as a filter for the DC-DC converter.

### CROSS-REFERENCE TO RELATED APPLICATION

This application claims the benefit of U.S. Provisional Patent Application 61/540,185 filed on 28 Sep. 2011, entitled RESONANT DC TRANSFORMER, the entirety of which is incorporated by reference herein.

### TECHNICAL FIELD

This disclosure relates to electronic circuits and particularly to DC-DC converter circuits.

### BACKGROUND

There is an increasing demand for electrical power conversion circuitry to operate with increased efficiency and reduced power dissipation to accommodate the continuous reduction in size of electronic devices. Switching converters have been implemented as an efficient mechanism for providing a regulated output in power supplies. Many different classes of switching converters exist today.

As a further example, a resonant power converter can be configured with a resonant tank that conducts an oscillating resonant current based on a power storage interaction between a capacitor an inductor, and switching waveform. The oscillating resonant current can include zero crossing operations of the switches correlated with zero crossings of the switching waveforms. As a result, resonant power converter can be implemented to achieve very low switching loss, and can thus be operated at substantially high switching frequencies.

### SUMMARY

In one example, a DC-DC converter includes a waveform generator that generates an output waveform for the DC-DC converter based on a DC input voltage. A rectifier rectifies the output waveform from the waveform generator to generate a rectified voltage for the DC-DC converter. A tank circuit having an inductor and a capacitor can be configured to have a resonant frequency that is correlated with a frequency of the output waveform, wherein the capacitor of the tank circuit also functions as a filter for the DC-DC converter.

In another example, a DC-DC converter includes a waveform generator that generates an output waveform for the DC-DC converter based on a DC input voltage. The DC-DC converter includes a rectifier that rectifies the output waveform from the waveform generator to generate a rectified voltage for the DC-DC converter. This can include a transformer having an inductance value configured as tank circuit with a capacitor to have a resonant frequency that is correlated with a frequency of the output waveform, wherein the capacitor of the tank circuit also functions as a filter for the DC-DC converter.

In yet another example, an apparatus includes a waveform generator that generates an output waveform for a DC-DC converter based on a DC input voltage. A rectifier rectifies the output waveform from the waveform generator to generate a rectified voltage for the DC-DC converter. A transformer having an inductance value can be configured as tank circuit with a capacitor to have a resonant frequency that is correlated with a frequency of the output waveform, wherein the capacitor of the tank circuit also functions as a filter for the DC-DC converter. A first power switch can receive the output waveform and drive a primary side of the transformer.

### BRIEF DESCRIPTION OF THE DRAWINGS

FIG. 1 illustrates an example of a DC-DC converter that employs a dual-function circuit to operate the DC-DC converter and filter voltages of the converter.

FIG. 2 illustrates an example of a double-ended DC/DC converter circuit employing multiple capacitors for a tank circuit and a filter of the converter.

FIG. 3 illustrates an example waveform diagram for a DC-DC converter depicted in FIG. 2.

FIG. 4 illustrates alternative examples of dual-function circuits that employ resonant circuits and filters in a DC-DC converter.

FIG. 5 illustrates example DC-DC converter circuits that employ a transformer and voltage doubler for a tank circuit and filter in the converter.

FIG. 6 illustrates an example DC-DC converter circuit that employs a single-ended configuration in the converter.

FIG. 7 illustrates alternative examples of DC-DC converter circuits that employ a single-ended configuration in the converter.

FIG. 8 illustrates an example DC-DC converter that employs a single inductor and voltage doubler for a tank circuit and filter in the converter.

FIG. 9 illustrates an example DC-DC converter circuit that employs a transformer and voltage doubler in a half-bridge configuration for a tank circuit and filter in the converter.

FIG. 10 illustrates an example DC-DC converter circuit that employs a transformer and voltage doubler in a full-bridge configuration for a tank circuit and filter in the converter.

### DETAILED DESCRIPTION

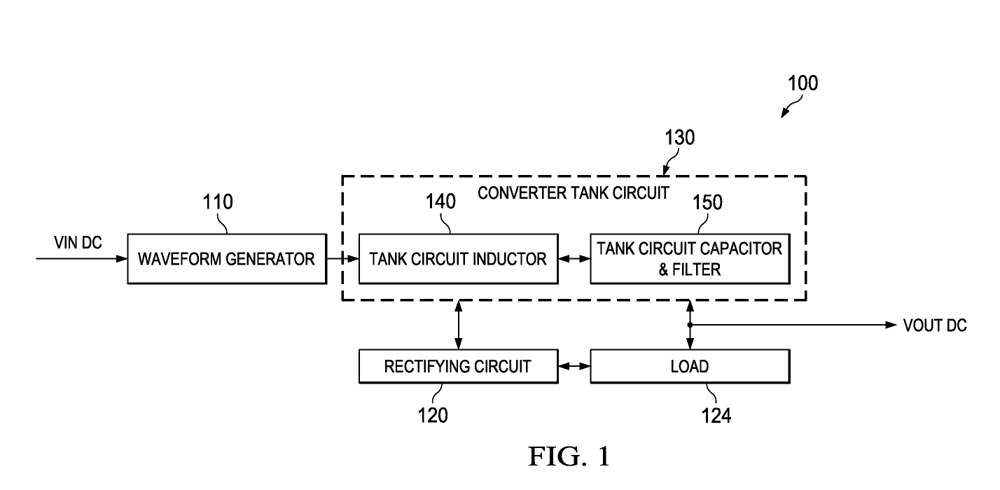

FIG. 1 illustrates an example of a DC-DC converter 100 that employs a dual-function circuit to operate the DC-DC converter and filter voltages of the converter. As used herein, the term DC-DC converter is used to indicate that an input DC voltage, shown as VIN DC is transformed to a subsequent DC voltage (e.g., same or different) at its output and shown as VOUT DC. A synonymous term is a DC transformer or Resonant DC transformer that also converts VIN DC to VOUT DC. In one example, the DC-DC converter 100 can be configured in a step-up voltage configuration between the DC input voltage VIN DC and the DC output voltage VOUT DC (e.g., output voltage generated higher than input voltage). In another example, a step-down voltage configuration between the DC input voltage and the DC output voltage is possible (e.g., output voltage generated lower than input voltage). In yet another configuration, an isolation configuration is provided wherein the DC input voltage is substantially the same as the DC output voltage yet some form of isolation is provided between the input voltage and the output voltage of the converter such as through a transformer as will be illustrated and described below. Isolated step-up or step-down configurations are also possible. Other configurations for the DC-DC converter 100 can also include an impedance matching configuration wherein the output impedance of the DC-DC converter is different from the input impedance of the DC-DC converter.

The DC-DC converter 100 operates near resonance of a waveform generator 110 that generates an output waveform (e.g., square wave) for the DC-DC converter based on the DC input voltage VIN DC. A rectifying circuit 120 (also referred to as rectifier) rectifies the output waveform from the waveform generator 110 to provide a rectified DC voltage that leads to the generation of VOUT DC across a load 124 in the DC-DC converter 100. A tank circuit 130 having an inductor 140 and a capacitor 150 can be configured to have a resonant frequency that is correlated with a frequency of the output waveform from the waveform generator 110. The capacitor 150 of the tank circuit 130 also functions as a filter for the DC-DC converter 100.

As will be illustrated and described below, the portions of the tank circuit 130 can be applied as a resonant circuit and filter on an input side of the DC-DC converter 100 (e.g., on the primary side of a transformer), on an output side of the DC-DC converter (e.g., on the secondary side of a transformer), or portions can appear on both the input side and the output side of the DC-DC converter 100. For example, in one example configuration, the tank circuit capacitor 150 can be segmented into multiple capacitors and applied on both the primary side and secondary side of a transformer having a leakage inductor that resonates with the multiple capacitors and further where the capacitors are employed in a dual role as filters for the DC-DC converter 100.

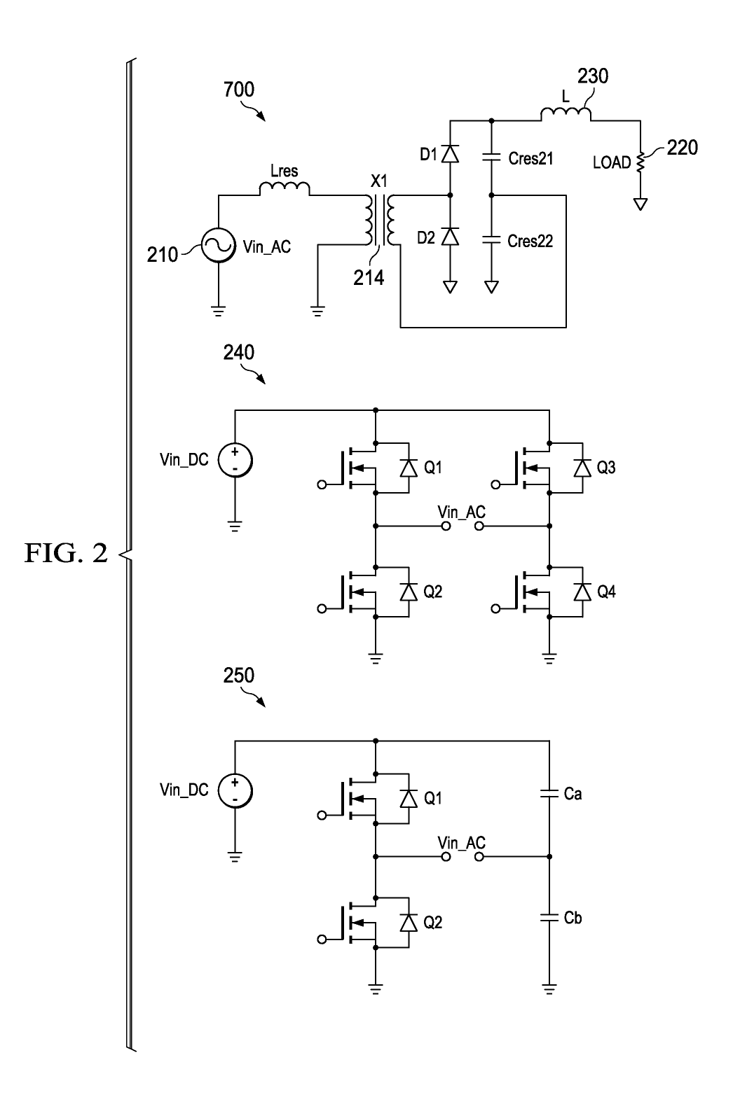

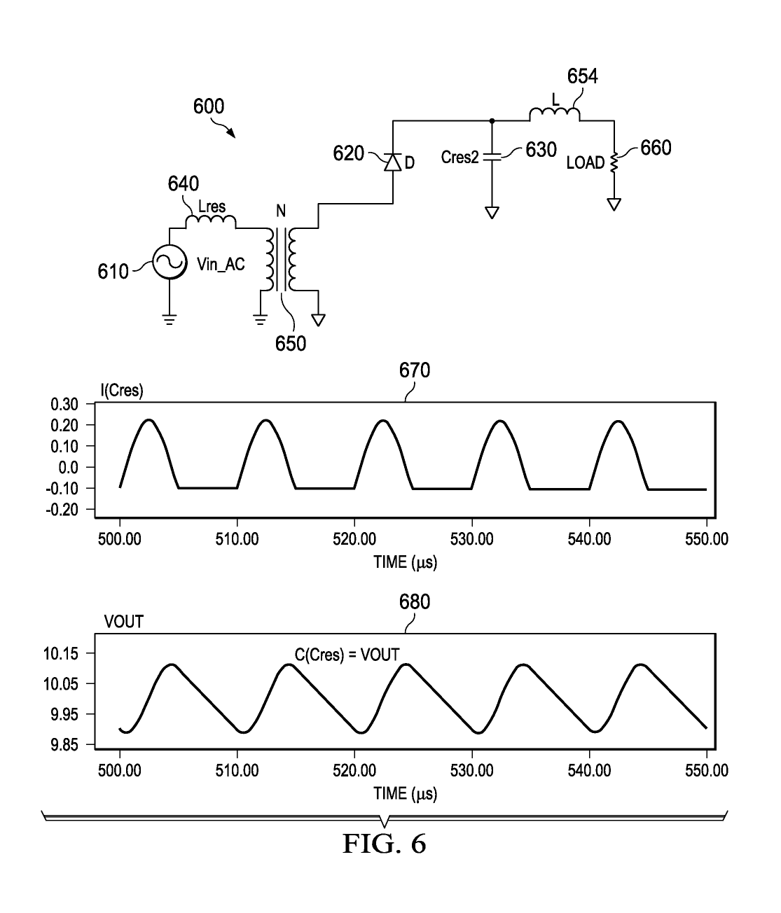

In a multiple capacitor example such as illustrated in FIG. 2 and described below, a double-ended configuration can be provided wherein a first capacitor and inductor, and rectifier circuit resonate and filter on one half of an AC cycle, and a second capacitor and rectifier along with the inductor form a second resonant circuit and filter on a subsequent portion of the AC cycle. In another example, a single-ended configuration can be provided (See e.g., FIG. 6), wherein half of the capacitors and rectifiers employed in the double-ended configuration are utilized. Thus, resonance and filtering are provided on a single portion of the AC cycle as opposed to both portions of the double-ended configuration. In other words, the single-ended configuration (e.g., single rectifier, single capacitor) is merely a logical subset of the double-ended configuration (e.g., multiple rectifier and multiple capacitor configuration).

As shown, the tank circuit capacitor 150 can be configured to provide dual-functionality for the DC-DC converter 100. In a first functional role, the tank circuit capacitor 150 operates with the tank circuit inductor 140 to form a resonant (or near resonant) tank circuit 130 for the DC-DC converter 100 that is driven and tuned about at the frequency of the waveform generator 110. In a second functional role, the tank circuit capacitor 150 operates as a filter for the DC-DC converter 100 (e.g., input and/or output filter). By employing the tank circuit capacitor 150 in a dual-functional role, the DC-DC converter 100 can be simplified with respect to parts counts since separate capacitors are not needed for both resonant operations and filtering. As will be described and illustrated below, a plurality of configurations are possible for the DC-DC converter 100. This can include multiple rectification options, wherein single or multiple rectifiers are employed for the rectifying circuit 120. The tank circuit capacitor 150 can be utilized in a single capacitor configuration or can be coupled with another capacitor in a double-ended configuration, for example. Similarly, the tank circuit inductor 140 could be provided as a separate inductor or provided as part of a leakage inductance such as from the primary side of a transformer for example. Various configurations are also possible for the waveform generator 110.

Before proceeding with various circuit examples, some descriptions of the different configurations for the DC-DC converter 100 are provided. In one example, a transformer can be coupled to the rectifier circuit 120, wherein a leakage inductance of a primary side of the transformer functions as the inductor 140 of the tank circuit 130. For example, a first connection of the primary side of the transformer can be coupled to the DC input voltage and a second connection of the primary side of the transformer can be coupled to a power switch that is driven from the waveform generator 110.

In another example configuration, the capacitor 150 can be configured as a first capacitor and a second capacitor operating as a voltage doubler in the DC-DC converter 100 and the rectifier circuit 120 can be configured as a first diode and a second diode coupled across the voltage doubler. The voltage doubler configuration of the DC-DC converter 100 can also include a transformer having a primary side and a secondary side, wherein the secondary side can be coupled to the voltage doubler and the first and second diode of the rectifier circuit 120. In one specific example that will be illustrated and described below, the secondary side of the transformer can be configured in a center-tap parallel configuration with the voltage doubler and the first and second diode of the rectifying circuit 120. In another configuration, a first secondary inductor and a second secondary inductor can be coupled to the first capacitor and the second capacitor of the voltage doubler. This can include having the secondary side of the transformer configured in a center-tap series configuration with the voltage doubler and the first and second diode as will be illustrated and described below.

In yet another configuration for the DC-DC converter 100, a first power switch and a second power switch can be configured to drive the primary side of the transformer in a half bridge configuration. This can include providing a first input capacitor and a second input capacitor that are operative with the first power switch and the second power switch. In another configuration, a third power switch and a fourth power switch can be employed to drive the primary side of the transformer in a full bridge configuration. In yet another example, the filter can be configured as an input filter on a primary side of a transformer or an output filter on a secondary side of the transformer. The filter can form a portion of the tank circuit 130 in the primary side and the secondary side of the transformer. It is noted that the examples described herein can be provided via different circuit implementations.

FIG. 2 illustrates an example of a double-ended DC/DC converter circuit 200 employing multiple capacitors for a tank circuit and a filter of the converter. The operation of the circuit 200 can be based on two independent resonant circuits driven by a square wave AC source at 210 and transformer 214, and driving a 1st resonant circuit active during the positive half cycle of the square wave and a 2nd resonant circuit active during the negative half cycle. The 1st resonant circuit comprises inductor Lres and capacitor Cres21. The 2nd resonant circuit comprises inductor Lres and capacitor Cres22. During a given half period, one of the resonant capacitors is idle, wherein the idle resonant capacitor is disconnected from the rest of the circuit by diodes D1 and D2.

The current in the resonant inductor Lres is the sum of the currents in the resonant capacitors Cres21 and Cres22 and can have a quasi-sine waveform that will cross zero coincidentally with the zero crossing of the input voltage square wave if the frequency Fsw of the square wave is equal to 0.872*Fres, where Fres is the resonant frequency of Cres21−Lres and Cres22−Lres (typically, Cres21 and Cres22 are about equal). The current zero crossing points generally do not change with variation in input voltage or output load, thereby allowing easy realization of “soft” zero voltage switching (ZVS) switching). The factor 0.872 (numerically calculated and rounded off) is a constant specific to the topologies of the various circuit examples described herein. At steady state (e.g., assuming unity transformer turns ratio), a voltage develops across each resonant capacitor having an average value equal to the amplitude of the input square wave and an AC component that can be attenuated to a desired value by appropriately increasing the value of the resonant capacitors (while reducing the value of the resonant inductor Lres in order to maintain the operating frequency). By making the resonant inductor as small as possible and the resonant capacitor as large as possible for the desired operating frequency, three benefits are realized: (1) the resonant capacitors become large enough to also act as output or input filters (2) the reactive power processed by the resonant components is minimized, thereby power losses are reduced and (3) the value of the resonant inductor may be made equal to the leakage inductance of the transformer, thereby eliminating the need for an explicit resonant inductor.

It is noted that while operating the converters as described herein at a frequency of 0.872 of the resonant frequency of the tank(s) is suitable for fixed input to output voltage ratio “DC Transformer” applications, wherein deviation from this value allows to dynamically alter the input to output voltage ratio of the converter.

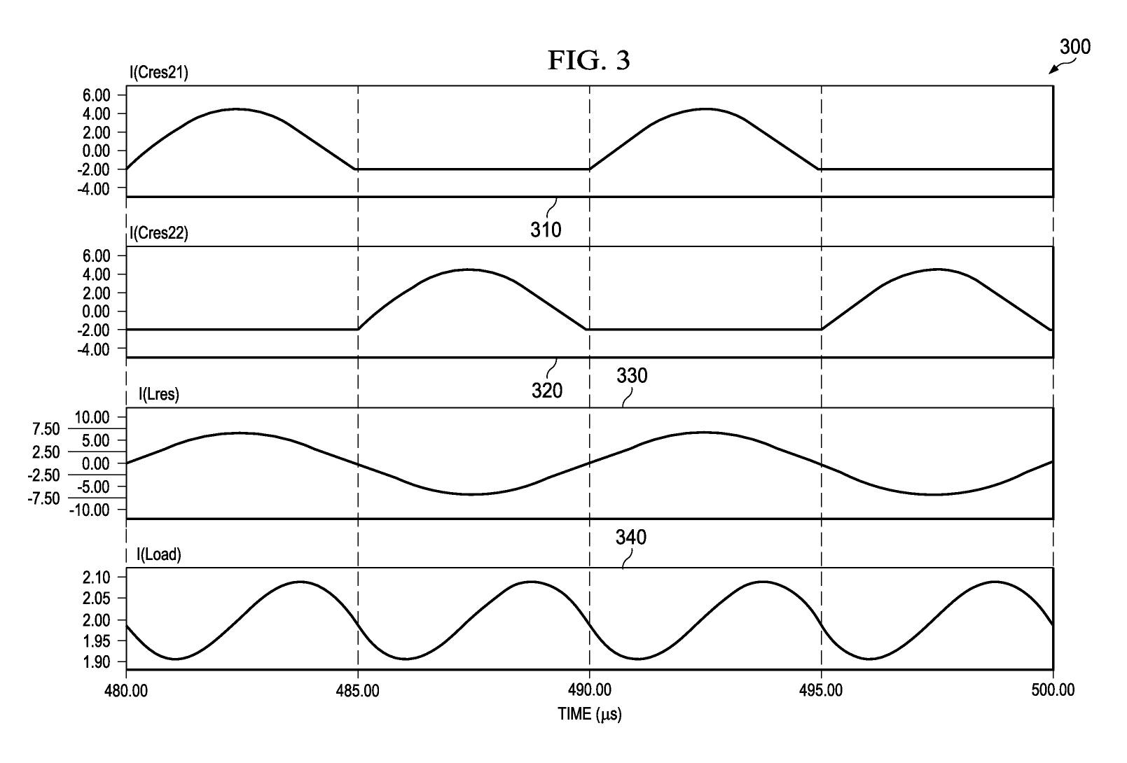

The output Load at 220 can be connected across the resonant capacitors Cres21 and Cres22 and it can be observed that the load is neither in parallel nor in series with either resonant circuit. If the load 220 is heavily capacitive, its capacitance can appear as an AC short circuit across the resonant capacitors thereby disrupting the operation of the circuit 200. To avoid this, a small decoupling inductor L 230 may have to be added in series with the load 220. For the source voltage at 210, a full-bridge configuration such as shown at 240 can be provided to drive the transformer 214, or in another example, a half bridge configuration such as shown at 250 can be employed. A related diagram of FIG. 2 is shown as FIG. 3 and illustrates an example waveform diagram 300 for a DC-DC converter depicted in FIG. 2. A current diagram 310 depicts rectified current flowing though the capacitor Cres21 illustrated in FIG. 2. A current diagram 320 depicts rectified current flowing though the capacitor Cres22 illustrated in FIG. 2. A diagram 330 depicts current through the resonant inductor Lres and a diagram 340 depicts load current through the load 220.

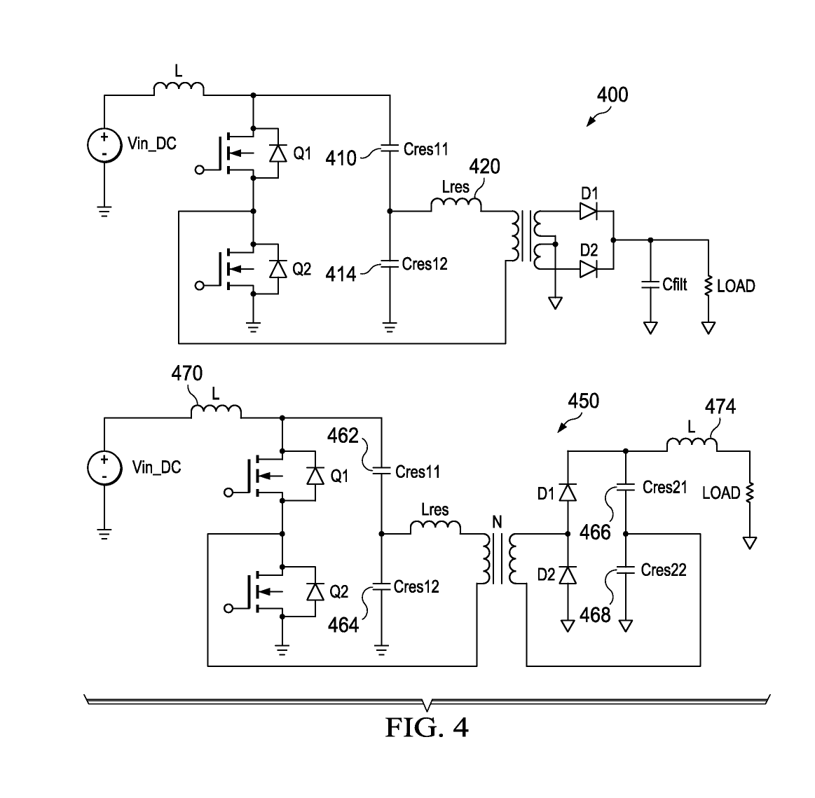

FIG. 4 illustrates alternative examples of dual-function circuits that employ resonant circuits and filters in a double-ended DC-DC converter. A circuit 400 depicts a double-ended configuration such as shown in FIG. 2 with resonant capacitors 410 and 414 resonating with a primary inductor 420 and also serving the dual role in the converter as an input filter in this example. Thus, the capacitor 410 forms a first resonant circuit with the inductor 420 on one half of an AC cycle, and the capacitor 414 forms a resonant circuit on the other half cycle. An inductor 430 can be provided to provide AC isolation yet pass DC voltages in the circuit 400.

In a circuit example shown at 450, the resonant circuit can be split into four capacitors 462, 464, 466, and 468, wherein capacitors 462 and 464 also function as input filters for the circuit 450 and capacitors 466 and 468 function as output filters, while each of the capacitors operate an individual resonant circuit depending on the cycle of the input waveform. As shown, inductors 470 and 474 can be provided to provide AC isolation yet pass DC voltages in the circuit 450.

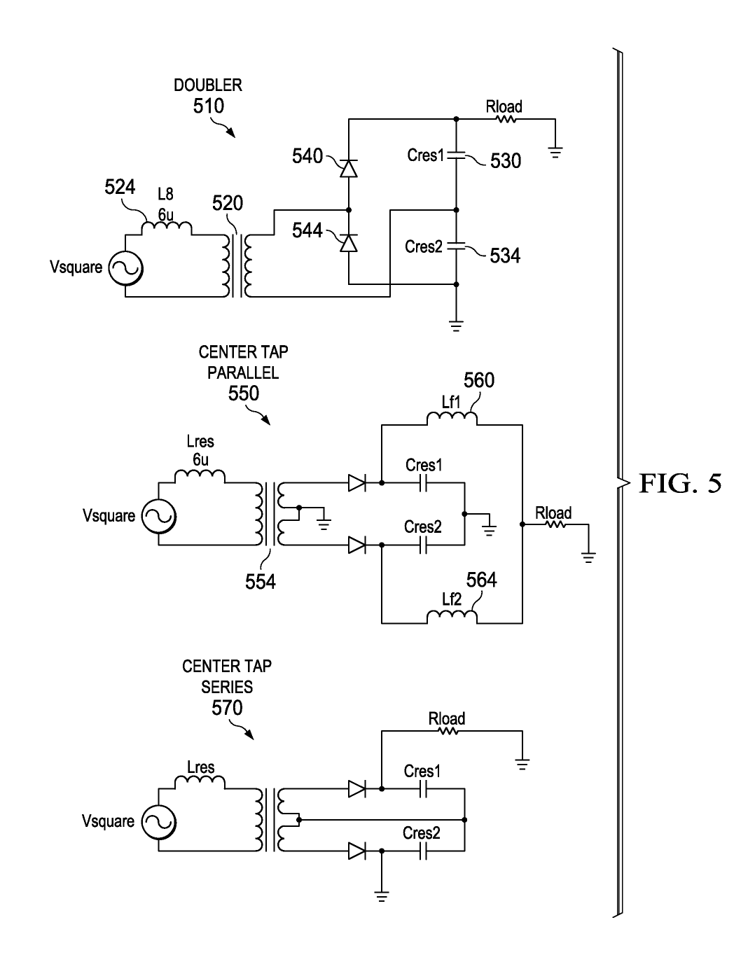

FIG. 5 illustrates example DC-DC converter circuits that employ a transformer and voltage doubler for a tank circuit and filter in the converter. A circuit 510 illustrates a basic voltage doubler configuration and similar to FIG. 2 described above that also utilizes a transformer 520 having a leakage inductance 524 that resonates with voltage doubler capacitors 530 and 534. A diode pair at 540 and 544 is connected across capacitors 530 and 534 and collectively drive load 546. A circuit 550 illustrates a center-tap parallel configuration wherein two windings are provided on a secondary at 554 and connected at a common point between the windings. Inductors 560 and 564 are added to avoid an AC short circuit between the resonant capacitors. A third example circuit is illustrated at 570. In this example at 570, a series configuration is provided wherein the common connection of the two windings of the secondary are connected to the junction of the resonant capacitors but no longer connected to ground as in the center-tap parallel circuit 550.

FIG. 6 illustrates an example DC-DC converter circuit 600 that employs a single-ended configuration in the converter. In contrast to the circuit depicted in FIG. 2 that employs two resonant circuits—one for each half cycle of the input AC, the circuit 600 employs a single resonant circuit and filter combination that resonates on a half cycle of an input voltage source 610. As shown, a single rectifier 620 and resonant capacitor 630 are employed in conjunction with a leakage inductance 640 of a transformer 650. An AC blocking buffer inductor 654 can be supplied to prevent the capacitance included in load 660 from appearing in parallel with the resonant capacitor 630 or to allow parallel connection of the outputs of any number of the DC-DC converters 660. At 670, a waveform shows the current in the capacitor 630, whereas a waveform 680 shows the output voltage waveform across the load 660.

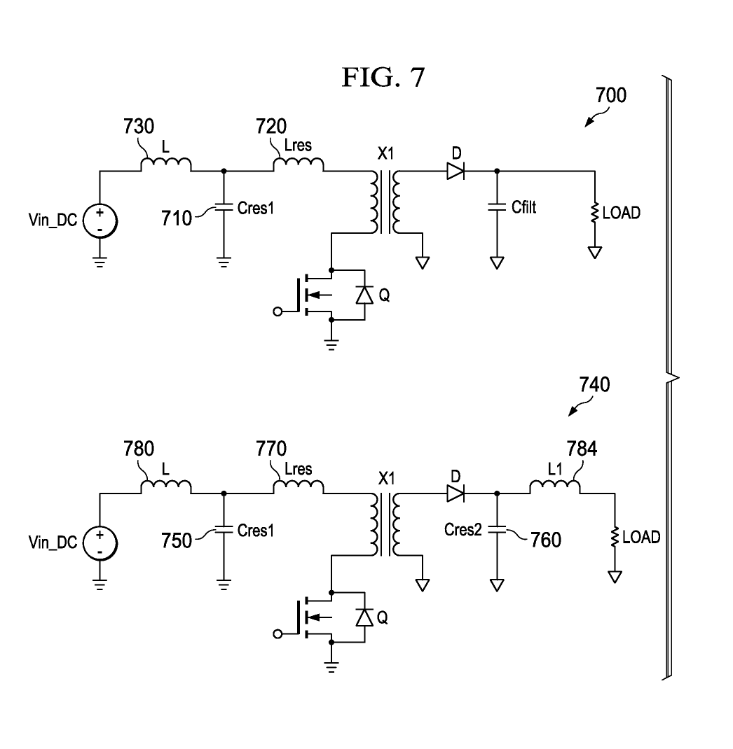

FIG. 7 illustrates alternative examples of DC-DC converter circuits that employ a single-ended configuration in the converter. At 700, a single-ended DC-DC converter employs a resonant capacitor 710 and leakage inductance 720 as a resonant circuit and input filter combination. Similar to the circuits described above, an buffer inductor 730 can also be provided. At a circuit 740, an input capacitor 750 and output capacitor 760 can be provided to form resonant circuits with a leakage inductance 770 and also form input and output filters for the DC-DC converter 740. As shown, buffer inductors 780 and 784 can be similarly provided as previously described to isolate AC voltages from the circuit and allow DC voltages to pass.

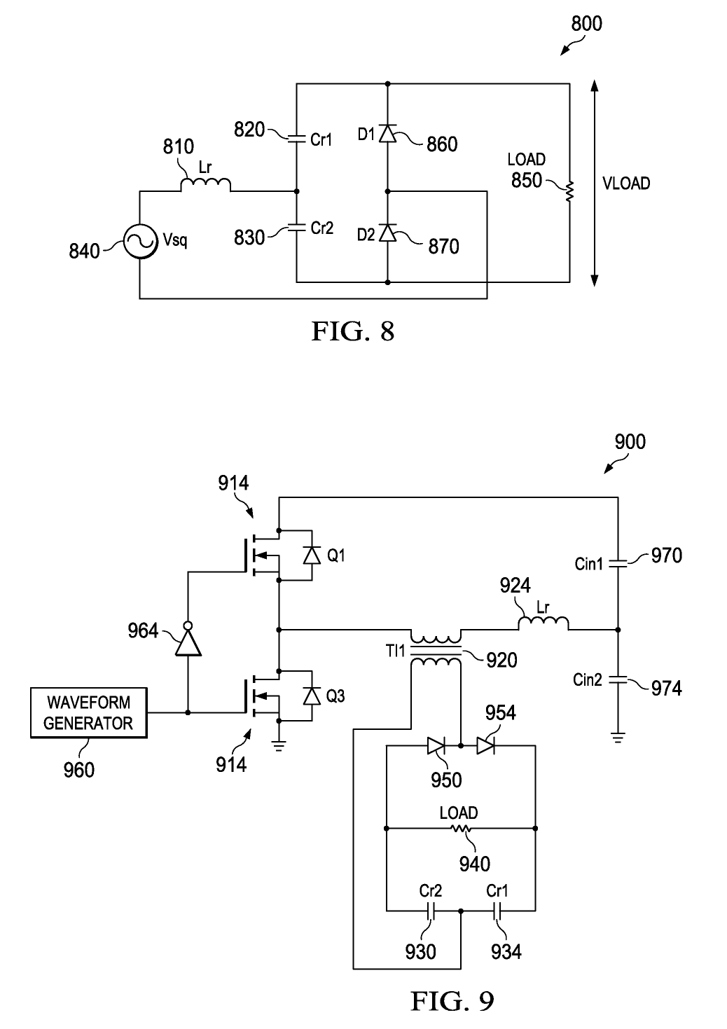

FIG. 8 illustrates an example DC-DC converter 800 that employs a single inductor 810 and voltage doubler comprising a first capacitor 820 and a second capacitor 830, wherein the first and second capacitors are collectively referred to as the voltage doubler for a tank circuit and filter in the converter. The first and second capacitors 820 and 830 operate as a tank circuit with the inductor 810 and resonate at (or about) a frequency supplied by a waveform generator 840. The voltage doubler with capacitors 820 and 830 also serve as an output filter capacitor for a load 850 which is also rectified by diodes 860 and 870, respectively. The waveform generator 840 can have a frequency slightly lower than the resonant frequency of the inductor 810 and the parallel combination of capacitors 820 and 830, which act both as resonant capacitor and output filter, in this example. As shown, the output of the circuit 800 is in parallel with the series connected capacitors 820 and 830. It is noted that the load 850 may be connected directly across the capacitors or additional filtration can be added. The added filter may have either capacitive or inductive input, for example. The operating frequency of the circuit is typically a weak function of the filter characteristic.

FIG. 9 illustrates an example DC-DC converter circuit 900 that employs a transformer and voltage doubler in a half-bridge configuration for a tank circuit and filter in the converter. The DC-DC converter 900 includes first power switch 910 and a second power switch 914 that drive a primary of a transformer 920. A leakage inductance 924 forms a tank circuit with capacitors 930 and 934 which are configured as a voltage doubler and appear across a load 940. Diodes 950 and 954 rectify the secondary side of the transformer 920. As shown, a waveform generator drives an inverter 964 and provides complimentary inputs to the power switches 910 and 914. Input capacitors 970 and 974 can also be provided in the half-bridge configuration.

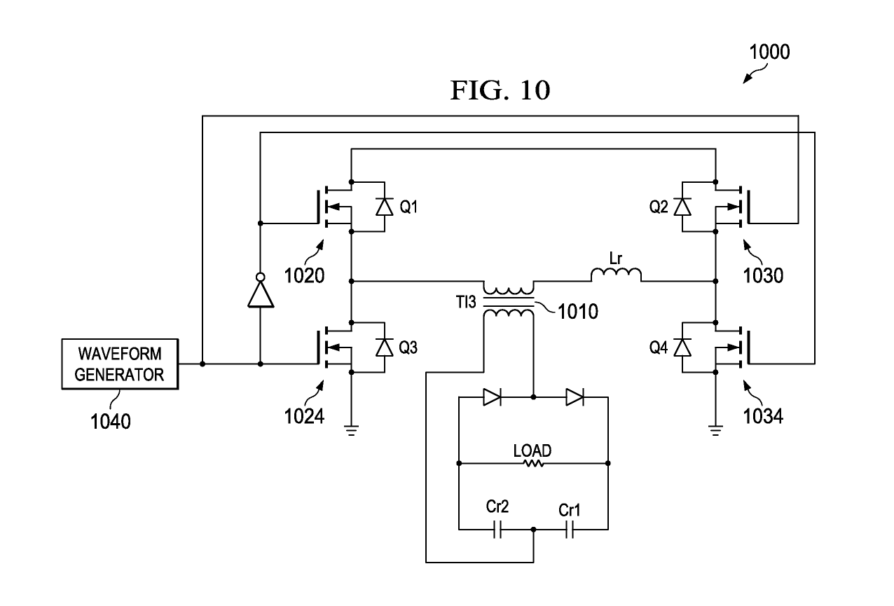

FIG. 10 illustrates an example DC-DC converter circuit 1000 that employs a transformer and voltage doubler in a full-bridge configuration for a tank circuit and filter in the converter. In this example, the primary side of a transformer 1010 is driven by four power switches 1020-1034 in contrast to the two-switch configuration of FIG. 6. Thus, two switches such as the switch 1020 and 1034 operate in a push-pull mode on one half cycle of a waveform generator 1040 and the other pair of switches 1024 and 1030 operates in push-pull mode on the other half cycle of the waveform generator 1040 to drive the primary of the transformer 1010. As shown, the secondary side of the transformer 1010 is connected and operated the same as what was previously described for the circuit 900 described above with respect to FIG. 9.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A DC-DC converter, comprising:
a waveform generator that generates an output waveform for the DC-DC converter based on a DC input voltage;
a rectifier that rectifies the output waveform from the waveform generator to generate a rectified voltage for the DC-DC converter; and
a tank circuit having an inductor and a capacitor configured to have a resonant frequency that is correlated with a frequency of the output waveform, wherein the capacitor of the tank circuit also functions as a filter for the DC-DC converter.

2. The DC-DC converter of claim 1, further comprising a transformer coupled to the rectifier, wherein a leakage inductance of a primary side of the transformer functions as the inductor of the tank circuit.

3. The DC-DC converter of claim 2, wherein a first connection of the primary side of the transformer is coupled to the DC input voltage and a second connection of the primary side of the transformer is coupled to a power switch that is driven from the waveform generator.

4. The DC-DC converter of claim 1, wherein the capacitor is configured as a first capacitor and a second capacitor operating as a voltage doubler in the DC-DC converter, and wherein the rectifier is configured as a first diode and a second diode coupled across the voltage doubler.

5. The DC-DC converter of claim 4, further comprising a transformer having a primary side and a secondary side, wherein the secondary side is coupled to the voltage doubler and the first and second diode.

6. The DC-DC converter of claim 5, wherein the secondary side of the transformer is configured in a center-tap parallel configuration and the first and second diode.

7. The DC-DC converter of claim 6, further comprising a first secondary inductor and a second secondary inductor that are coupled to the first capacitor and the second capacitor of the voltage doubler.

8. The DC-DC converter of claim 5, wherein the secondary side of the transformer is configured in a series configuration with the first and second diode.

9. The DC-DC converter of claim 5, further comprising a first power switch and a second power switch to drive the primary side of the transformer in a half bridge configuration.

10. The DC-DC converter of claim 9, further comprising a first input capacitor and a second input capacitor that are operative with the first power switch and the second power switch.

11. The DC-DC converter of claim 9, further comprising a third power switch and a fourth power switch to drive the primary side of the transformer in a full bridge configuration.

12. The DC-DC converter of claim 1, wherein the filter is configured as an input filter on a primary side of a transformer or an output filter on a secondary side of the transformer.

13. The DC-DC converter of claim 12, wherein the filter forms a portion of the tank circuit in the primary side and the secondary side of the transformer.

14. A DC-DC converter, comprising:
a waveform generator that generates an output waveform for the DC-DC converter based on a DC input voltage;
a rectifier that rectifies the output waveform from the waveform generator to generate a rectified voltage for the DC-DC converter; and
a transformer having an inductance value configured as tank circuit with a capacitor to have a resonant frequency that is correlated with a frequency of the output waveform, wherein the capacitor of the tank circuit also functions as a filter for the DC-DC converter.

15. The DC-DC converter of claim 14, wherein the filter is configured as an input filter on a primary side of the transformer, as an output filter on the secondary side of the transformer, or as an input and output filter on both the primary and secondary sides of the transformer.

16. The DC-DC converter of claim 15, wherein the transformer includes a secondary having at least two windings configured in a center tap parallel configuration with a load or configured in a center tap series configuration with the load.

17. The DC-DC converter of claim 16, further comprising a second capacitor operating as a voltage doubler with the tank circuit capacitor.

18. An apparatus, comprising:
a waveform generator that generates an output waveform for a DC-DC converter based on a DC input voltage;
a rectifier that rectifies the output waveform from the waveform generator to generate a rectified voltage for the DC-DC converter;
a transformer having an inductance value configured as tank circuit with a capacitor to have a resonant frequency that is correlated with a frequency of the output waveform, wherein the capacitor of the tank circuit also functions as a filter for the DC-DC converter; and
a first power switch to receive the output waveform and drive a primary side of the transformer.

19. The apparatus of claim 18, further comprising a second power switch to drive the primary side of the transformer in a half bridge configuration.

20. The apparatus of claim 19, further comprising a third power switch and a fourth power switch to operate with the first power switch and the second power switch to drive the primary side of the transformer in a full bridge configuration.
